(19) United States
(12) Patent Application Publication
(10) Pub. No.: US 2016/0084789 A1
(43) Pub. Date: Mar. 24, 2016

(54) METHOD FOR INSPECTING COMPOSITE MATERIAL COMPONENTS

(71) Applicant: U.S. Army Research Laboratory ATTN: RDRL-LOC-1, Adelphi, MD (US)

(72) Inventors: Geoffrey A. Slipher, Baltimore, MD (US); Robert A. Haynes, Bel Air, MD (US); Jaret C. Riddick, Aberdeen, MD (US)

(21) Appl. No.: 14/799,821

(22) Filed: Jul. 15, 2015

Related U.S. Application Data
(60) Provisional application No. 62/054,411, filed on Sep. 24, 2014.

(51) Int. Cl. G01N 27/20; G01N 27/04

(52) U.S. Cl. CPC G01N 27/20; G01N 27/041

(57) ABSTRACT

A method for inspecting a component constructed of a conductive composite material. The method includes the step of passing an alternating current signal through the component through an electrical interface. The impedance of the component from either a reflected or a through passage of the electric signal is then determined. That impedance is then compared with empirical data to determine the type and extent of damage or deterioration of the component.

### CROSS REFERENCE TO RELATED APPLICATIONS

This application claims the benefit of U.S. provisional patent application Ser. No. 62/054,411 filed Sep. 24, 2014 which is herein incorporated by reference.

### GOVERNMENT INTEREST

The invention described herein may be manufactured, used, and licensed by or for the United States Government.

### BACKGROUND OF THE INVENTION

I. Field of the Invention

The present invention relates generally to material inspection methods and, more particularly, to a method for inspecting a component constructed of a conductive composite material.

II. Description of Related Art

Conductive composite materials, such as carbon fiber reinforced composite materials, are rapidly gaining widespread use for a variety of applications pertaining to aircraft, spacecraft, and civil infrastructure. In many applications, however, it is necessary to monitor the structural condition of the composite material component to ensure the health and safety of the overall structure.

In some cases, sensors are used to provide data from which an estimate of the state of damage and/or deterioration of the composite material in a structure may be determined along with the remaining useful life of that structure. Such damage can include, for example, fracture of carbon fibers within the structural material, delamination of the composite material, as well as other types of deterioration.

Electrical resistance measurements have also shown some promise in the detection of damage in the fiber composites, particularly in those systems where embedded sensors or electrical networks are used. In these, cases, electrical interfaces are applied to the structural component and the electrical resistance between those electrical interfaces measured. Since the fracture of carbon fibers within the composite material increases the overall electrical resistance of the composite material, an increased electrical resistance between the electrical interfaces is indicative of damaged carbon fibers within the composite material.

While the previously .known methods for determining the electrical resistance between two electrical interfaces on the composite component are effective for identifying certain types of damage in the composite material, other types of damage and/or deterioration of the composite component may occur with little or no change in the electrical resistance of the component. Consequently, in these cases the composite component may suffer serious structural damage or deterioration.

### SUMMARY OF THE PRESENT INVENTION

The present invention provides a method for inspecting conductive composite materials which overcomes the above mentioned disadvantages of the previously known methods.

In brief, in the method of the present invention an alternating current signal is passed through the component constructed of composite material through an electrical interface. That alternating current signal, furthermore, may vary over a wide range of frequencies.

Using either the reflective signal through the same electrical interface, or through passage of the signal between two separated electrical interfaces, electrical impedance of the component is determined. This electrical impedance contains not only the real or resistive value, but also the imaginary component of the impedance which contains phase information for the impedance. Furthermore, such electrical impedance measurements are more sensitive and selective to damage detection by using a full complex plane analysis of the impedance signal.

The impedance signal measured from the component is then compared with impedance signal information empirically measured for the same component having a known structural integrity. The change in impedance is then compared with a predictive electrical model based on the electrical pathway through the component. Specific changes in the specimen state (e.g. stress, delamination, or fiber fracture) are associated with specific anticipated changes in electrical impedance from the model. As such, variations between the measured impedance signal for the component under test, and the impedance signal for previously measured components having known structural properties enable the structural properties of the component under test to be accurately determined. Furthermore, since the impedance of the electrical signal, rather than simple resistance, is being employed for inspection of the structural integrity of the component, the structural integrity of the component may not only be more accurately determined, but different types of structural damage or deterioration, such as fiber fracture, delamination, etc., may be accurately identified.

Additionally, several different pathways through the component especially relative to anticipated areas of damage (e.g. holes for fasteners, or other areas of anticipated stress concentration), are preferably measured and compared with previously obtained empirical data.

### BRIEF DESCRIPTION OF THE DRAWING

A better understanding, of the present invention will be had upon reference to the following detailed description when read in conjunction with the accompanying drawing, wherein like reference characters refer to like parts throughout the several views, and in which;

FIG. 1A is a side view of an exemplary sample component;

FIG. 1B is a top view of an exemplary sample component;

FIG. 2A is a graph of the stress sensitivity of the phase angle versus, frequency for pathway A1-B1 for the exemplary sample component;

FIG. 2B is a graph of the stress sensitivity of the phase angle versus frequency for pathway A2-B2 for the exemplary sample component;

FIG. 2C is a graph of the stress sensitivity of the phase angle versus frequency for pathway A3-B2 for the exemplary sample component;

FIG. 2D is a graph of the stress sensitivity of the phase angle versus frequency for pathway A4-B3 for the exemplary sample component;

FIG. 2E is a graph of the stress sensitivity of the phase angle versus frequency for the pathway A5-B3 for the exemplary sample component;

FIG. 3A is a graph of the damage sensitivity of the absolute value of the impedance as a function of frequency for pathway A1-B1 for the exemplary component;

FIG. 3B is a graph of the damage sensitivity of the absolute value of the impedance as a function of frequency for pathway A2-B2 for the exemplary component;

FIG. 3C is a graph of the damage sensitivity of the absolute value of the impedance as a function of frequency for pathway A3-B2 for the exemplary component;

FIG. 3D is a graph of the damage sensitivity of the absolute value of the impedance as a function of frequency for pathway A4-B3 for the exemplary component; and

FIG. 3E is a graph of the damage sensitivity of the absolute value of the impedance as a function of frequency for pathway A5-B3 for the exemplary component

### DETAILED DESCRIPTION OF PREFERRED EMBODIMENTS OF THE PRESENT INVENTION

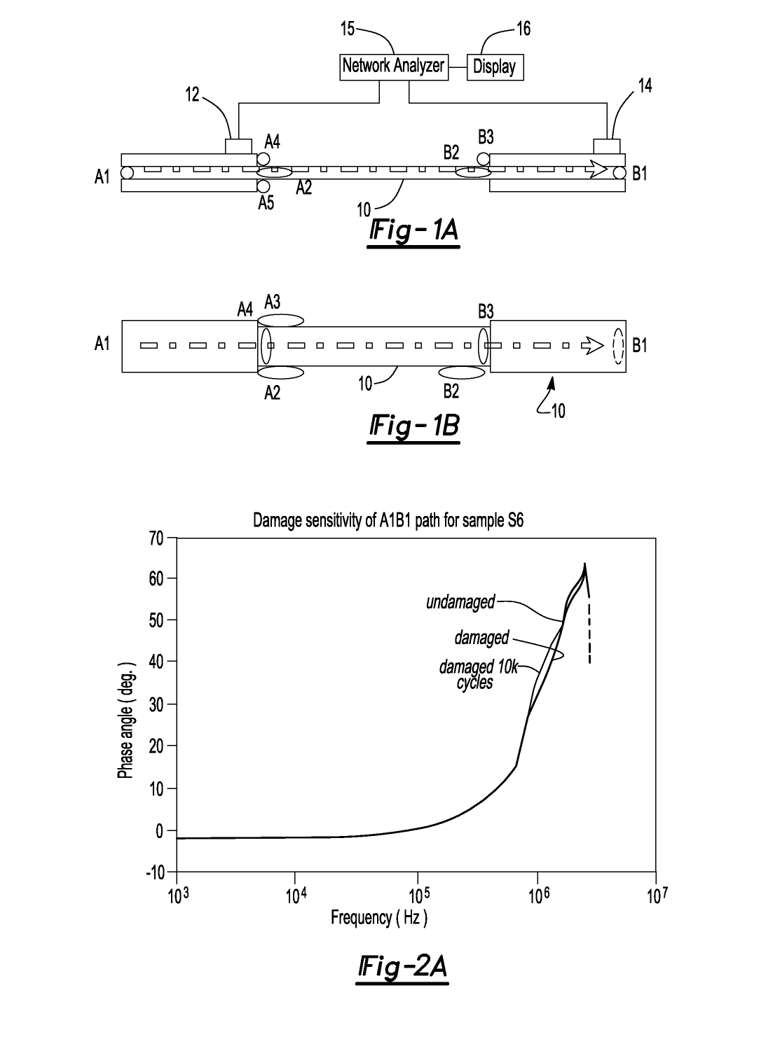

With reference first to FIGS. 1A and 1B, a component 10 constructed of a conductive composite material is shown. The composite material may comprise, for example, a polymer with carbon fibers or carbon nanotubes. The component 10 also includes a number of different locations

which are marked A1-A5 and B1-B3 for convenience purposes only.

An electrical interface 12 is connected to a first location, such as location A4, on the component 10. Similarly, a second electrical interface 14 is also attached to the component 10 at a second location, such as B1. Each electrical interface 12 and 14, furthermore, is attached to the component 10 in a fashion that provides a low resistance electrical connection between the interfaces 12 and 14 and the component 10.

An electrical interrogation circuit capable of measuring the electrical impedance in the frequency range of interest (e.g. a network analyzer) 15 is then electrically connected to both electrical interfaces 10 and 12. When activated, the interrogation circuit 15 generates an alternating current signal through the component 10. This alternating current signal, furthermore, may vary in frequency between, for example, 1 kilohertz and 10 megahertz in a continuous fashion.

The interrogation circuit 15 also determines the impedance of the component 10 between two points, such as points A4 and B1, and records and/or displays the impedance values on a display 16. This impedance value, furthermore, includes both the real portion or resistive portion, of the impedance, as well as the imaginary portion or phase of the impedance value.

The impedance measurement made by the interrogation circuit is then compared with previously obtained empirical data for the same component 10 in a known structural condition. For example, if the impedance determined from the component under test matches the empirical data for the same component which was known to be structurally undamaged, the component 10 would likewise, be undamaged. Conversely, variations in the impedance received by the component 10 under test as compared with previously determined empirical tests of structurally sound components are indicative not only of the magnitude of the structural damage of the component 10, but also the type of damage, and/or loading state of the component. The type of damage could include, for example, fracture of carbon fibers or carbon nanotubes, delamination, and the like.

Sample specimens were manufactured from a woven graphite/epoxy material system with a thickness of 3 mm and cut to dimensions of 25 mm by 300 mm. All specimens underwent cyclic loading with predefined pauses to record impedance measurements. Silver epoxy was used to attach wire leads to the specimen (Sample S6) in the configuration shown in Figure 1, Five different electrical paths were interrogated through the specimen: A1-B1, A2-B-2, A3-B2, A4-B3, and A5-B3. Electrical impedance was measured using an Agilent E5061B-LF network analyzer (NA) using a port 1-2 thru series method. Prior to initiating sample characterization, a calibration procedure was executed on the NA that pushed the calibration plane out to the specimen. The A1-A5 connections were used to inject the electrical signal through port 1, and the B1-B3 connections were connected to port 2 for the NA return. For the fatigue tests, cyclic loading was applied as described above. Cyclic loading was stopped periodically and logarithmic frequency scans were performed with the NA from 1 kHz to 100 MHz for both statically loaded (55 kN) and unloaded states through each of the five electrical paths. Impedance magnitude and phase angle data were collected and saved. The electrical interrogation signal was a sine wave of varying frequency with power of 10 dBm (707 mV @ 50 ohm).

Although the previously described examination of the component 10 has been an examination of the through impedance between locations A4 and B1 on the component 10, during a full-scale analysis of the structural integrity of the component 10, multiple impedance measurements may be made between different pathways on the component. For example, after the impedance between locations A4 and B1 has been determined, the locations between A4 and B2 may be determined. Next the impedance between locations A2 and B3 may be determined and so on. In this fashion, the structural integrity of the component 10 may be completely inspected and determined.

The testing of the component 10 thus far described has been limited to through passage impedance of the component 10, i.e., the impedance between two separate locations on the component 10. Alternatively, however, the interrogation circuit 15 may be electrically connected to a single location, e.g. location A4, through an electrical interface and the reflected value of the signal used to determine the impedance of the component 10.

The method of the present invention also enables the component's fatigue life to be estimated by testing the component under stress. With the component under stress, the network analyzer 15 is utilized to determine the impedance between multiple paths through the component 10.

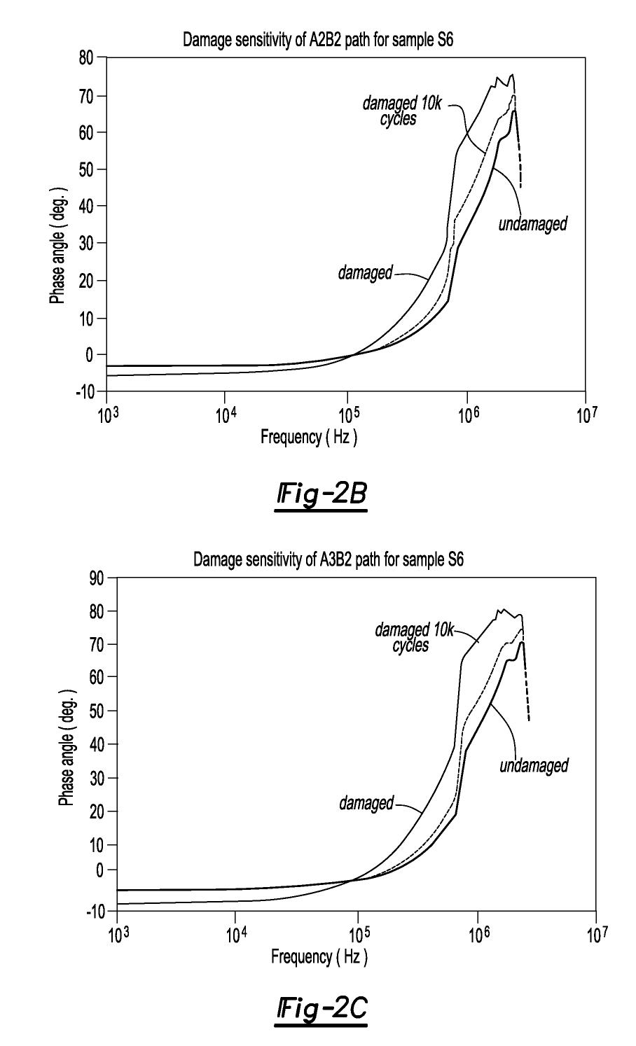

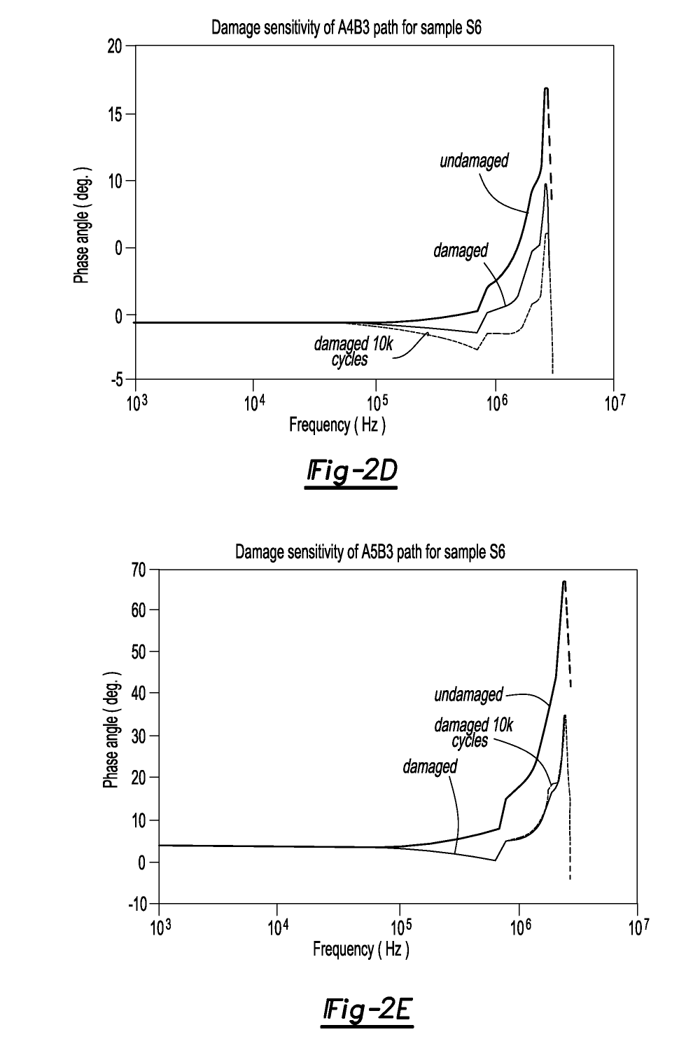

For example, FIGS. 2A-2E show the phase angle versus frequency for the part between several different pathways for the part for both a damaged and undamaged component.

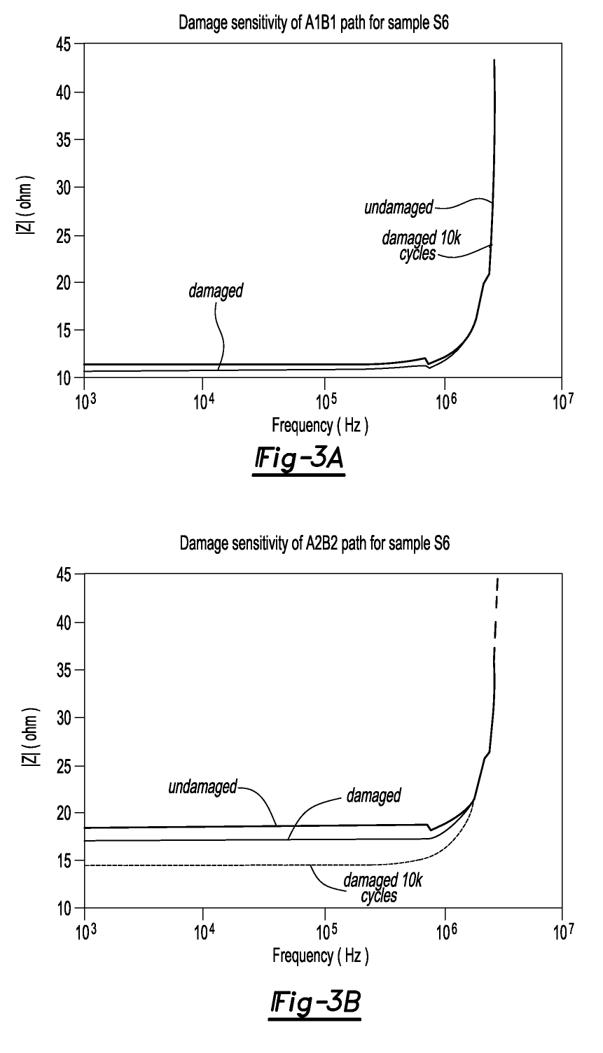

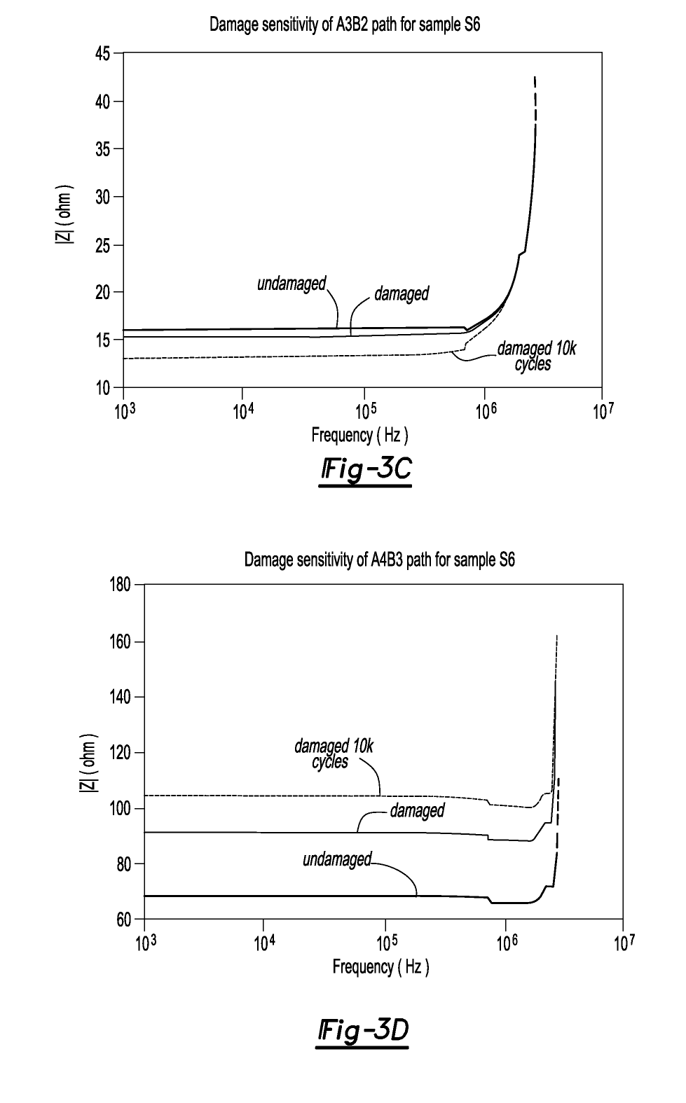

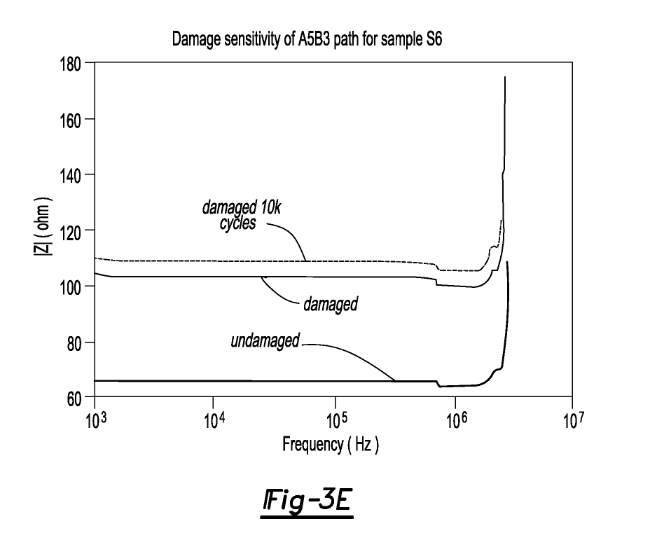

Similarly, FIGS. 3A-3E illustrate the damage sensitivity for the component for several different pathways as a function of the absolute value of the impedance on the vertical axis versus the frequency on the horizontal axis for both damaged and undamaged components.

From the foregoing, it can be seen that the present invention provides a unique method for inspecting components made from conductive composite materials. By utilizing the impedance of the material through different pathways of the component, not only is more accurate measurement of the structure of the component achieved, but also the type of damage may be identified.

Having described our invention, however, many modifications thereto will become apparent to those skilled in the art to which it pertains without deviation from the spirit of the invention as defined by the scope of the appended claims.

We claim:

1. A method for inspecting a conductive composite material component comprising the steps of:
passing an alternating current signal through the component through an electrical interface,
determining the impedance of the component from a reflected or through passage of said signal,
comparing the determined impedance with empirical data to determine the type and extent of damage to the component.

2. The method as defined in claim 1 wherein said electric signal varies in frequency and wherein the impedance is determined for a plurality of different frequencies.

3. The method as defined in claim 1 and comprising attaching a second electrical interface to the component and wherein the impedance of the component is measured between said first and second electrical interfaces.

4. The method as defined in claim 1 wherein the impedance of a reflected signal is measured at said first electrical interface.

5. The method as defined in claim 1 and further comprising the step of imposing a mechanical load on the component during said impedance determining step.

6. The method as defined in claim 1 wherein the component is a carbon fiber reinforced polymer.

7. The method as defined in claim 1 and comprising the steps of determining the impedance for at least two different current flow paths through the component.

8. The method as defined in claim 1 and further comprising the step of measuring a phase shift, if any, between the injected signal and the measured signal and comparing that phase shift to empirical data relating phase shift to damage or deterioration of the component.
